(19) United States
(12) Patent Application Publication
(10) Pub. No.: US 2007/0263639 A1
(43) Pub. Date: Nov. 15, 2007

(54) IP telephone remote control system

(75) Inventor: Kentarou Abe, Kawasaki-shi (JP)

Correspondence Address: YOUNG & THOMPSON, 745 SOUTH 23RD STREET, 2ND FLOOR, ARLINGTON, VA, 22202, US

(73) Assignee: NEC INFRONTIA CORPORATION, KAWASAKI-SHI (JP)

(21) Appl. No.: 11/727,970

(22) Filed: Mar. 29, 2007

(30) Foreign Application Priority Data
Mar. 30, 2006 (JP) 2006-094531

(51) Int. Cl. H04L 12/66; H04L 12/56; H04L 12/28

(52) U.S. Cl. 370/400; 370/356

(57) ABSTRACT

An IP telephone, a main apparatus, and a PC are connected to a network. The PC is installed with a PC application for remote-controlling the IP telephone. The IP telephone has a port for communication with the PC application via the network. The PC recognizes the IP telephone as a remote-controlled IP telephone via the network by the use of the PC application, produces a remote control instructing command (log information collection instructing command or upgrade instructing command) for the IP telephone by the use of the PC application, and transmitting the remote control instructing command to the network, thereby remote-controlling (instructing log information collection or upgrading) the IP telephone not through the main apparatus.

This application claims priority to prior Japanese patent application JP 2006-94531, the disclosure of which is incorporated herein by reference.

### BACKGROUND OF THE INVENTION

This invention relates to an IP telephone remote control system In a telephone system in which IP (Internet Protocol) telephones and a main apparatus are connected to a network, change of setting of an IP telephone may abruptly become necessary in a maintenance work. For example, the change of setting of the IP telephone is change of setting of the IP telephone in order to resolve a problem caused in the IP telephone or upgrading of firmware of the IP telephone. The change of setting of the IP telephone is not troublesome if the number of the IP telephones to be changed in setting is small. However, in order to carry out the change of setting of the IP telephones, more than 1000 in number, a long time and a high cost are required. This invention relates to an IP telephone remote control system capable of efficiently and accurately carrying out a setting change operation of the IP telephone by remote control.

Referring to FIG. 1, an IP telephone remote control system as a related art will be described. The system comprises a network 11, a main apparatus 12, IP telephones 13 to 15, and a PC (Personal Computer) 18. The network 11 is typically a LAN (Local Area Network). To the network 11, the main apparatus 12 and the IP telephones 13 to 15 are connected. The PC 18 is connected to the main apparatus 12. The PC 18 sends a command to each of the IP telephones 13 to 15 via the main apparatus 12 to carry out remote control.

In the above-mentioned IP telephone remote control system, it is assumed that there arises a problem in at least one of the IP telephones 13 to 15. In this event, it is necessary to quickly obtain, as telephone data, the state of the IP telephone or telephones in question and failure information. The telephone data are acquired from the main apparatus 12. Therefore, in absence of a repairer of the main apparatus 12, the telephone data can not be acquired.

Further, when a maintenance work of the main apparatus 12 is carried out, upgrading of firmware of the IP telephones 13 to 15 may simultaneously be carried out. Upon carrying out such upgrading, if the maintenance work of the main apparatus 12 is not carried out and the main apparatus 12 performs a normal operation, the PC 18 can transmit a download instructing command for upgrading firmware (upgrade instructing command) to all IP telephones including the IP telephones 13 to 15 through the main apparatus 12. In response to the download instructing command, each of the IP telephones can automatically download data for upgrading the firmware from a FTP (File Transfer Protocol) server equipped in the PC 18. However, in case where the maintenance work of the main apparatus 12 is being carried out, the main apparatus 12 can not be used. In this event, the PC 18 can not transmit the download instructing command to all IP telephones including the IP telephones 13 to 15 via the main apparatus 12. If the data for upgrading the firmware are manually downloaded to the IP telephones one by one, a long time is consumed.

Japanese Unexamined Patent Application Publication (JP-A) No. 2002-111868 (Patent Document 1) discloses in FIG. 1 that change of set data in a main apparatus 11 of a key telephone apparatus 10 is carried out by a setting PC 12 (see paragraph [0009] in Patent Document 1) and that change of set data in the main apparatus 11 is carried out by a system control server 21 (see paragraph [0015] in Patent Document 1).

Japanese Unexamined Patent Application Publication (JP-A) No. H8-340561 (Patent Document 2) discloses in FIGS. 1 and 2 that change of set data in a main apparatus 101 of a key telephone system is carried out by a PC 201 in a center system (see paragraphs [0021], [0022], and [0026] of Patent Document 2).

Thus, in each of the Patent Documents 1 and 2, change of the set data in the main apparatus is carried out by the PC. Neither the Patent Document 1 nor the Patent Document 2 discloses or suggests the change of setting in the IP telephone.

As described above, in the IP telephone remote control system illustrated in FIG. 1, each of the IP telephones 13 to 15 is operated by an instruction from the PC 18 via the main apparatus 12. It is often that the IP telephones 13 to 15 are upgraded simultaneously with the maintenance work of the main apparatus 12, such as repair and upgrading, as described above. However, during the maintenance work of the main apparatus 12, the download instructing command for upgrading (upgrade instructing command) can not be transmitted from the PC 18 to the IP telephones 13 to 15. Further, in order to acquire the information about the IP telephones 13 to 15 upon occurrence of a problem in the IP telephones 13 to 15, it is necessary to call the repairer of the main apparatus 12 in order to acquire the information about the IP telephones 13 to 15.

### SUMMARY OF THE INVENTION

It is therefore an object of this invention to provide an IP telephone remote control system capable of carrying out remote control of an IP telephone without relying upon a main apparatus.

It is another object of this invention to provide an IP telephone remote control system capable of transmitting an upgrade instructing command to an IP telephone or acquiring information from the IP telephone without relying upon a main apparatus.

IP telephone remote control systems according to this invention are as follows:

(1) An IP telephone remote control system comprising a network, an IP telephone connected to the network, a main apparatus connected to the network, and a remote controller connected to the network;

the remote controller being installed with an application for remote-controlling the IP telephone;

the IP telephone having a port for communication with the application via the network;

the remote controller recognizing, by the use of the application and via the network, the IP telephone as a remote-controlled IP telephone, producing a remote control instructing command for the IP telephone by the use of the application, and transmitting the remote control instructing command to the network, thereby remote-controlling the IP telephone not through the main apparatus.

(2) The IP telephone remote control system as described in (1), wherein:

the remote controller producing, by the use of the application, a telephone information collection instructing command for instructing the IP telephone to collect telephone information as the remote control instructing command for the IP telephone, transmitting the telephone information collection instructing command to the network, and making the IP telephone return log information of the IP telephone as the telephone information.

(3) The IP telephone remote control system as described in (1), wherein:

the remote controller producing, by the use of the application, an upgrade instructing command for instructing the IP telephone to carry out upgrading as the remote control instructing command for the IP telephone, transmitting the upgrade instructing command to the network, and making the IP telephone carry out upgrading.

(4) The IP telephone remote control system as described in (1), wherein:

the remote controller is a PC and the application is a PC application.

(5) An IP telephone remote control system comprising a network, an IP telephone connected to the network, a main apparatus connected to the network, and a remote controller connected to the network;

the remote controller being installed with an application for remote-controlling the IP telephone;

the IP telephone having a port for communication with the application via the network;

the remote controller producing, by the use of the application, a terminal recognition request command for recognition of the IP telephone as a remote-controlled IP telephone and transmitting the terminal recognition request command to the network;

the remote controller producing, in response to a terminal recognition response command from the IP telephone as a response to the terminal recognition request command, a remote control instructing command for the IP telephone by the use of the application, and transmitting the remote control instructing command to the network, thereby remote-controlling the IP telephone not through the main apparatus.

(6) The IP telephone remote control system as described in (5), wherein:

the remote controller producing, by the use of the application, a telephone information collection instructing command for instructing the IP telephone to collect telephone information as the remote control instructing command for the IP telephone, transmitting the telephone information collection instructing command to the network, and making the IP telephone return log information of the IP telephone as the telephone information.

(7) The IP telephone remote control system as described in (5), wherein:

the remote controller producing, by the use of the application, an upgrade instructing command for instructing the IP telephone to carry out upgrading as the remote control instructing command for the IP telephone, transmitting the upgrade instructing command to the network, and making the IP telephone carry out upgrading.

(8) The IP telephone remote control system as described in (5), wherein:

the remote controller is a PC and the application is a PC application.

According to this invention, there is obtained an IP telephone remote control system capable of carrying out remote control of an IP telephone by a remote controller (PC) not through a main apparatus but directly.

According to this invention, there is obtained an IP telephone remote control system capable of transmitting a download instructing command for upgrading firmware (upgrade instructing command) to an IP telephone by a remote controller (PC) not through a main apparatus but directly.

According to this invention, there is obtained an IP telephone remote control system capable of acquiring information from an IP telephone by a remote controller (PC) not through a main apparatus but directly.

### BRIEF DESCRIPTION OF THE DRAWINGS

FIG. 1 is a view for describing an IP telephone remote control system as a related art;

FIG. 2 is a view for describing an IP telephone remote control system according to one embodiment of this invention;

FIG. 3 is a view for describing a PC application created by a PC in the IP telephone remote control system illustrated in FIG. 2;

FIG. 4 is a view for describing a specific example of the IP telephone remote control system illustrated in FIG. 2; and

FIG. 5 is a view for describing an operation of the IP telephone remote control system illustrated in FIG. 4.

### DESCRIPTION OF THE PREFERRED EMBODIMENTS

Now, one embodiment of this invention will be described with reference to the drawing.

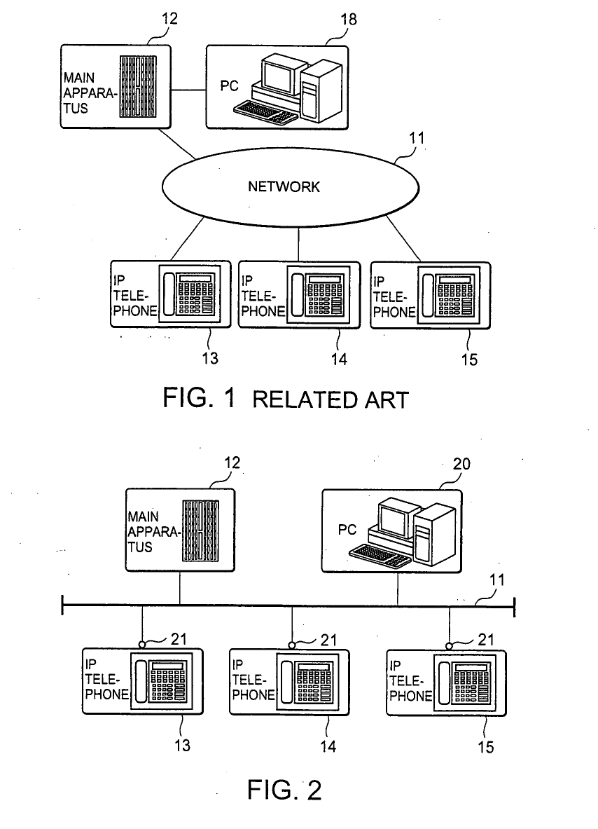

In the above-mentioned IP telephone remote control system illustrated in FIG. 1, remote control for the IP telephone is entirely carried out via the main apparatus. On the other hand, this invention is related to an IP telephone remote control system capable of carrying out remote control of an IP telephone by the use of a PC application not through a main apparatus. In the embodiment which will hereinafter be described, it is possible by the use of the PC application to efficiently obtain telephone data from the IP telephone and to quickly transmit to the IP telephone an upgrade instructing command (download instructing command for upgrading firmware).

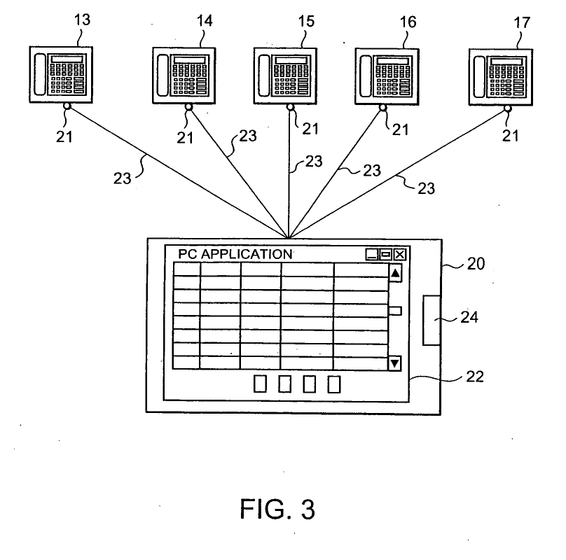

Referring to FIG. 2, an IP telephone remote control system according to one embodiment of this invention has similar parts designated by like reference numerals as those in FIG. 1. The IP telephone remote control system includes IP telephones 13 to 15 connected to a network 11. A PC (remote controller) 20 is connected to the network 11. Normally, a main apparatus 12 collects information about the IP telephones 13 to 15 and transmits a download instructing command for upgrading (upgrade instructing command) to the IP telephones 13 to 15. In this embodiment, even if the main apparatus 12 can not be accessed because of absence of a repairer or a network failure, a PC 20 can directly remote-control the IP telephones 13 to 15 by the use of a PC application 22 (FIG. 3) so as to upgrade the IP telephones 13 to 15 or to collect information from the IP telephones 13 to 15.

Referring to FIG. 3, the PC application 22 is created by the PC 20. The PC application 22 illustrated in the figure is a telephone remote control application software created by programming (VC (Visual C) or VB (Visual Basic) using the PC 20. By the PC application 22, remote control can be carried out for one or a plurality of the IP telephones 13 to 17. Each of the IP telephones 13 to 17 is provided with a port 21 for receiving and transmitting a command or the like from and to the PC application 22. As a transport protocol on a path 23 between the PC 20 and each of the IP telephones 13 to 17, a UDP (User Datagram Protocol) is used. Use may also be made of an Internet protocol such as a DHCP (Dynamic Host Configuration Protocol), a FTP (File Transfer Protocol), and a DNS (Domain Name System).

In FIG. 3, the PC 20 is provided with a FTP server 24 which stores data for upgrading the firmware of the IP telephones.

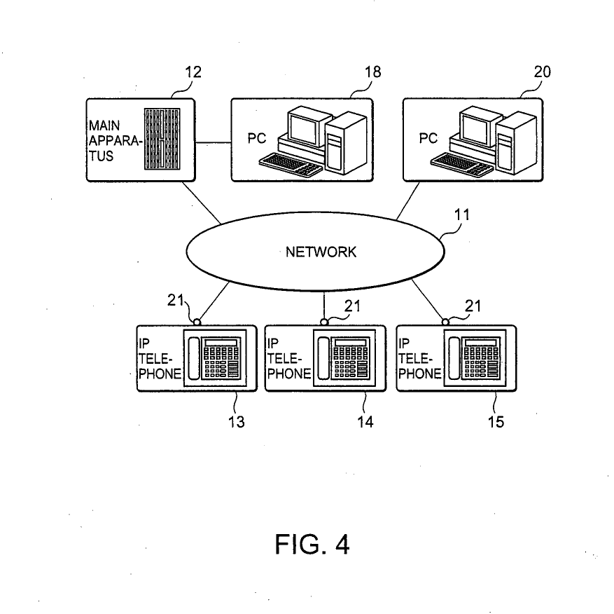

Referring to FIG. 4, a specific example of the IP telephone remote control system in FIG. 2 will be described. In FIG. 4, like the system in FIG. 1 as the related art, the PC 18 is connected to the main apparatus 12. The PC 18 sends a command to the IP telephones 13 to 15 through the main apparatus 12 to carry out remote control. In FIG. 4, the PC 20 installed with the PC application (telephone remote control application software) 22 described in conjunction with FIG. 3 is directly connected to the network 11 to which the IP telephones 13 to 15 provided with the ports 21 are connected. Thus, communication between the PC and the IP telephones can be carried out. With this structure, the PC 20 can transmit to the IP telephones 13 to 15 a command similar to that from the main apparatus 12. Each of the IP telephones 13 to 15 can receive the command from the main apparatus 12 as well as the command from the PC 20. Preferably, each IP telephone controls the command from the main apparatus 12 and the command from the PC 20 on an exclusive basis to process the commands from the main apparatus 12 and from the PC 20.

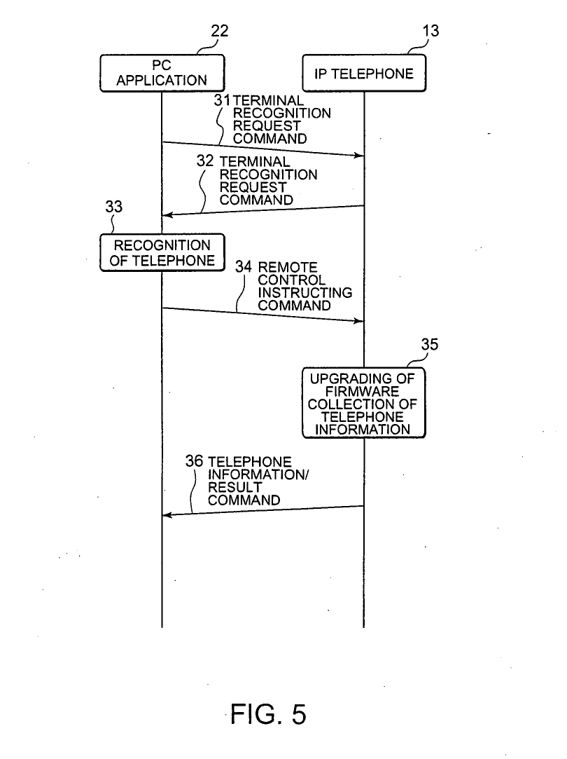

Next referring to FIG. 5, an operation of the system in FIG. 4 will be described. In FIG. 5, the IP telephone 13 is shown as a representative of the IP telephones 13 to 15. The remaining IP telephones are operable in a manner similar to the IP telephone 13.

At first, the PC application 22 of the PC 20 transmits a terminal recognition request command 31 for recognition of the IP telephone 13 to be remote-controlled (remote-controlled IP telephone). At this time, if it is desired to individually recognize the IP telephone whose IP address is preliminarily known, the command 31 is transmitted to a unicast address. Alternatively, if it is desired to recognize all of the IP telephones 13 to 15 in the network 11, the command 31 is transmitted to a broadcast address.

In response to the terminal recognition request command 31 sent to the unicast address of the IP telephone 13 or the terminal recognition request command 31 sent to the broadcast address, the IP telephone 13 returns a terminal recognition response command 32 to the PC application 22 of the PC 20.

The PC application 22 of the PC 20 receives the terminal recognition response command 32 and, after completion of recognition 33 of the IP telephone with reference to the terminal recognition response command 32, transmits a remote control instructing command 34. By transmission of the remote control instructing command 34, it is possible to carry out remote control such as collection of log information of the IP telephone, change of setting of the IP telephone, and upgrading of firmware inside the IP telephone.

For example, when a telephone information collection instructing command as the remote control instructing command 34 is supplied from the PC application 22 of the PC 20, the IP telephone 13 collects the log information in the IP telephone 13 as telephone information (telephone data) in response to the telephone information collection instructing command.

When an upgrade instructing command (download instructing command for upgrading the firmware) as the remote control instructing command 34 is supplied from the PC application 22 of the PC 20, the IP telephone 13 automatically downloads data for upgrading the firmware from the FTP server 24 (FIG. 3) in the PC 20 in response to the download instructing command.

In FIG. 3, the FTP server 24 which stores the data for upgrading the firmware is arranged inside the PC 20. Alternatively, the FTP server 24 may be arranged outside the PC 20 and connected to the network 11.

In FIG. 5, the IP telephone transmits, as a telephone information/result transmission command 36, the telephone information (telephone data) or the result of upgrading in response to the remote control instructing command 34, if necessary.

In FIGS. 3 and 4, the PC application 22 of the PC 20 transmits a state management command to the IP telephone as a recognized terminal at every predetermined time interval (for example, 70 minutes). The IP telephone as the recognized terminal receives the state management command and manages a newest or last state. Upon connection to the PC, the IP telephone as the recognized terminal holds information, such as an IP address, of the PC 20 connected thereto and does not accept a command from another PC having an IP address different from the IP address held as mentioned above. Thus, it is possible to prevent the IP telephone, which is remote-controlled by the PC application 22 of the PC 20, from being operated by another application in another PC. Furthermore, the IP telephone has a timer equipped inside. When no state management command is received for the above-mentioned predetermined time interval, the PC which has been connected to the IP telephone is deemed to be disconnected. Then, the IP telephone can receive a command from another PC.

Herein, description will be made of an initial operation when the IP telephone is turned on in FIGS. 3 and 4. When the IP telephone is turned on, the IP telephone searches the main apparatus 22. When the IP telephone can not be connected to the main apparatus 12 because of a network failure or the like, the IP telephone continuously searches the main apparatus 12. However, the network failure may occur at a switching hub between the main apparatus 12 and the IP telephone. Therefore, the IP telephone is reset if the IP telephone can not be connected to the main apparatus 12 for a predetermined time period (for example, 3 minutes). After resetting, the IP telephone searches the main apparatus 12 again.

In this case, upon resetting the IP telephone, the IP telephone may not receive the terminal recognition request command (connection instructing command) 31 (FIG. 5) even if the PC application 22 of the PC 20 transmits the terminal recognition request command. In order to avoid this, transmission of the terminal recognition request command (connection instructing command) is repeated several times. For example, by transmitting the terminal recognition request command (connection instructing command) a plurality of times (for example, more than 10 times) at an interval of 10 seconds, it is possible to connect the IP telephone and the PC application 22 of the PC 20.

The IP telephone being connected to the application 22 is not reset even after lapse of the predetermined time period (for example, three minutes).

As described above, with the IP telephone remote control system illustrated in FIGS. 3 and 4, it is possible to carry out collection of information of the IP telephone, change of setting, upgrading of the firmware only by using the PC application (telephone remote control application) 22 of the PC 20 by a maintenance worker without relying upon the main apparatus 12. Accordingly, it is unnecessary to call a repairer of the main apparatus 12. This brings about reduction in time and labor costs.

Although this invention has been described in conjunction with the preferred embodiment thereof, this invention is not limited to the foregoing embodiments but may be modified in various other manners within the scope of the appended claims.

What is claimed is:

1. An IP telephone remote control system comprising a network, an IP telephone connected to said network, a main apparatus connected to said network, and a remote controller connected to said network;
said remote controller being installed with an application for remote-controlling said IP telephone;
said IP telephone having a port for communication with said application via said network;
said remote controller recognizing, by the use of said application and via said network, said IP telephone as a remote-controlled IP telephone, producing a remote control instructing command for said IP telephone by the use of said application, and transmitting said remote control instructing command to said network, thereby remote-controlling said IP telephone not through said main apparatus.

2. The IP telephone remote control system as claimed in claim 1, wherein:
said remote controller producing, by the use of said application, a telephone information collection instructing command for instructing said IP telephone to collect telephone information as said remote control instructing command for said IP telephone, transmitting said telephone information collection instructing command to said network, and making said IP telephone return log information of said IP telephone as the telephone information.

3. The IP telephone remote control system as claimed in claim 1, wherein:
said remote controller producing, by the use of said application, an upgrade instructing command for instructing said IP telephone to carry out upgrading as said remote control instructing command for said IP telephone, transmitting said upgrade instructing command to said network, and making said IP telephone carry out upgrading.

4. The IP telephone remote control system as claimed in claim 1, wherein:
said remote controller is a PC and said application is a PC application.

5. An IP telephone remote control system comprising a network, an IP telephone connected to said network, a main apparatus connected to said network, and a remote controller connected to said network;
said remote controller being installed with an application for remote-controlling said IP telephone;
said IP telephone having a port for communication with said application via said network;
said remote controller producing, by the use of said application, a terminal recognition request command for recognition of said IP telephone as a remote-controlled IP telephone and transmitting said terminal recognition request command to said network;
said remote controller producing, in response to a terminal recognition response command from said IP telephone as a response to said terminal recognition request command, a remote control instructing command for said IP telephone by the use of said application, and transmitting said remote control instructing command to said network, thereby remote-controlling said IP telephone not through said main apparatus.

6. The IP telephone remote control system as claimed in claim 5, wherein:
said remote controller producing, by the use of said application, a telephone information collection instructing command for instructing said IP telephone to collect telephone information as the remote control instructing command for said IP telephone, transmitting said telephone information collection instructing command to said network, and making said IP telephone return log information of said IP telephone as the telephone information.

7. The IP telephone remote control system as claimed in claim 5, wherein:
said remote controller producing, by the use of said application, an upgrade instructing command for instructing said IP telephone to carry out upgrading as said remote control instructing command for said IP telephone, transmitting said upgrade instructing command to said network, and making said IP telephone carry out upgrading.

8. The IP telephone remote control system as claimed in claim 5, wherein:
said remote controller is a PC and said application is a PC application.
